(19) United States
(12) Patent Application Publication
(10) Pub. No.: US 2008/0001691 A1
(43) Pub. Date: Jan. 3, 2008

(54) MEMS switch and method of fabricating the same

(75) Inventors: Young-tack Hong, Suwon-si (KR); Jong-seok Kim, Hwaseong-si (KR); In-sang Song, Seoul (KR); Sang-wook Kwon, Seongnam-si (KR); Sang-hun Lee, Seoul (KR); Che-heung Kim, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/585,235

(22) Filed: Oct. 24, 2006

(30) Foreign Application Priority Data
Jun. 29, 2006 (KR) 2006-59439

(51) Int. Cl. H01F 7/08

(52) U.S. Cl. 335/220

(57) ABSTRACT

A MEMS switch includes a substrate, at least one signal line and at least one electrode formed on the substrate, and a moving beam disposed in a spaced-apart relation with respect to the substrate above the substrate so as to be connected with or disconnected from the signal line according to an operation of the electrode. The moving beam includes at least one body, and at least one support to support the body. The body has a modulus of elasticity larger than that of the support. The MEMS switch prevents the moving beam from being stuck and increases a contact force generating between the moving beam and the signal line, thereby enabling a signal to be stably transmitted.

This application claims priority under 35 U.S.C. § 119 (a) from Korean Patent Application No. 10-2006-59439 filed on Jun. 29, 2006 in the Korean Intellectual Property Office, the entire disclosure of which is incorporated herein by reference.

### BACKGROUND OF THE INVENTION

1. Field of the Invention

The present invention relates to a Micro Electro Mechanical System (MEMS) switch, and in particular, to a method of fabricating the MEMS switch.

2. Description of the Related Art

A MEMS technique is a technique of fabricating elements such as a micro switch, a mirror, a sensor, precision instrument parts, etc. using a semiconductor processing technique. The MEMS technique is acknowledged as a technique of increasing performance and reducing fabrication costs owing to the use of the semiconductor processing technique, which provides high precision in working, high uniformity of manufactures, superior productivity, etc.

Among elements using the MEMS technique as described above, a MEMS switch is most widely fabricated. A MEMS switch is often used in an impedance matching circuit or for selectively transmitting a signal in wireless communication terminals and systems of microwave or millimeter band.

A general MEMS switch is configured, so that signal lines and electrodes are formed on a substrate and a moving beam is disposed above or on the substrate in a spaced-apart relation with respect to the substrate so as to be connected to or disconnect from the signal lines according to whether a voltage is applied to the electrodes. However, since the moving beam has a thin thickness of approximately 1˜2 μm as compared with a length of several hundreds μm, it is bent greatly downward as a whole when the voltage is applied to the electrodes. Accordingly, a returning force of the moving beam is declined, thereby resulting in a problem, such as a sticking.

To address such a problem, MEMS switches were disclosed in U.S. Pat. Nos. 6,949,866 and 6,876,462. As illustrated in FIGS. 1A and 1B, the disclosed MEMS switches include bumps 7 formed on a substrate 1 or an undersurface of a moving beam 5 to prevent the moving beam 5 from being stuck. Accordingly, when electrodes 2 are applied with a voltage and thereby the moving beam 5 is moved downward, the moving beam 5 is supported by the bumps 7 at a certain position, so that a returning force of the moving beam 5 is improved. As a result, the moving beam 5 is prevented from being stuck.

A contact force F_{c} generating between the moving beam 5 and one of signal lines 3 in the operation of the disclosed MEMS switches is represented as the following mathematical formula 1.

F_{c}=Fₑ−(Fᵣ+F_{b}) [Mathematical formula 1]

Here, Fₑ is an electrostatic force, Fᵣ is a first reaction force, and F_{b} is a second reaction force.

As represented in the mathematical formula 1, the contact force F_{c} is a value, which deducts the first reaction force Fᵣ generated at a support 4 for the moving beam 5 and the second reaction force F_{b} generated by the bumps 7 from the electrostatic force Fₑ generated between the electrode 2 and the moving beam 5. That is, the contact force F_{c} in the disclosed MEMS switches includes the second reaction force F_{b}, which is generated by the bump 7 to be deducted from the electrostatic force Fₑ. Accordingly, since the contact force F_{c} generated between the moving beam 5 and the signal line 3 is weakened, a problem may occur, in that a signal is not stably transmitted. Also, to prevent the moving beam 5 from being stuck, there is a need for the MEMS switch to additionally install the bumps 7. Accordingly, working efficiency may be lowered.

### SUMMARY OF THE INVENTION

An aspect of the present invention addresses at least the above problems and/or disadvantages and provides at least the advantages described below. Accordingly, an aspect of the present invention is to provide a MEMS switch having an improved structure that can prevent a moving beam from being stuck and increase a contact force generating between the moving beam and a signal line, thereby enabling a signal to be stably transmitted.

Also, the present invention is not required to overcome the disadvantages described above, and an exemplary embodiment of the present invention may not overcome any of the problems described above. Additional aspects of the invention will be set forth in part in the description which follows and, in part, will be obvious from the description, or may be learned by practice of the invention.

According to one aspect of an exemplary embodiment of the present invention, a MEMS switch includes a substrate, at least one signal line and at least one electrode formed on the substrate, and a moving beam disposed in a spaced-apart relation with respect to the substrate above the substrate so as to be connected with or disconnected from the signal line according to an operation of the electrode. The moving beam includes at least one body, and at least one support to support the body. The body has a modulus of elasticity larger than that of the support.

The moving beam may be is configured, so that the body has a thickness larger than that of the support.

The moving beam may be configured, so that at least one support is disposed at each of both ends of the body.

Alternatively, the moving beam may be configured, so that at least one support is disposed at one end of the body.

Also, the moving beam may be configured, so that at least one support is disposed to connect two bodies with each other and to be pivotable.

According to another aspect of an exemplary embodiment of the present invention, a MEMS switch includes a substrate, at least one signal line and at least one electrode formed on the substrate, and a moving beam supported by an elastic member in a spaced-apart relation with respect to the substrate above the substrate, the moving beam being connected with or disconnected from the signal line according to an operation of the electrode. The moving beam has a modulus of elasticity larger than that of the elastic member.

According to still another aspect of an exemplary embodiment of the present invention, a method of fabricating a MEMS switch includes forming at least one signal line and at least one electrode on the substrate, and disposing a moving beam in a spaced-apart relation with respect to the substrate above the substrate, the moving beam being configured, so that a body has a modulus of elasticity larger than that of a support.

### BRIEF DESCRIPTION OF THE DRAWINGS

The above aspects and features of the present invention will be more apparent from the description for exemplary embodiments of the present invention taken with reference to the accompanying drawings, in which:

FIGS. 1A and 1B are schematic structure views exemplifying a related art MEMS switch;

FIG. 2A is a schematic structure view exemplifying a MEMS switch according to a first exemplary embodiment of the present invention;

FIG. 2B is a perspective view of a moving beam of the MEMS switch of FIG. 2A;

FIG. 2C is a view exemplifying an operation of the MEMS switch of FIG. 2A;

FIG. 3A is a schematic structure view exemplifying a MEMS switch according to a second exemplary embodiment of the present invention;

FIG. 3B is a perspective view of a moving beam of the MEMS switch of FIG. 3A;

FIG. 3C is a view exemplifying an operation of the MEMS switch of FIG. 3A;

FIG. 4A is a schematic structure view exemplifying a MEMS switch according to a third exemplary embodiment of the present invention;

FIG. 4B is a perspective view of a moving beam of the MEMS switch of FIG. 4A; and

FIG. 4C is a view exemplifying an operation of the MEMS switch of FIG. 4A.

FIG. 5 is a view exemplifying the correlation between the modulus of elasticity and the thickness of the moving beam.

Throughout the drawings, the same drawing reference numerals will be understood to refer to the same elements, features, and structures.

### DETAILED DESCRIPTION OF ILLUSTRATIVE, NON-LIMITING EMBODIMENTS OF THE INVENTION

Hereinafter, a MEMS switch and a method of fabricating the same according to exemplary embodiments of the present invention will now be described in greater detail with reference to the accompanying drawings.

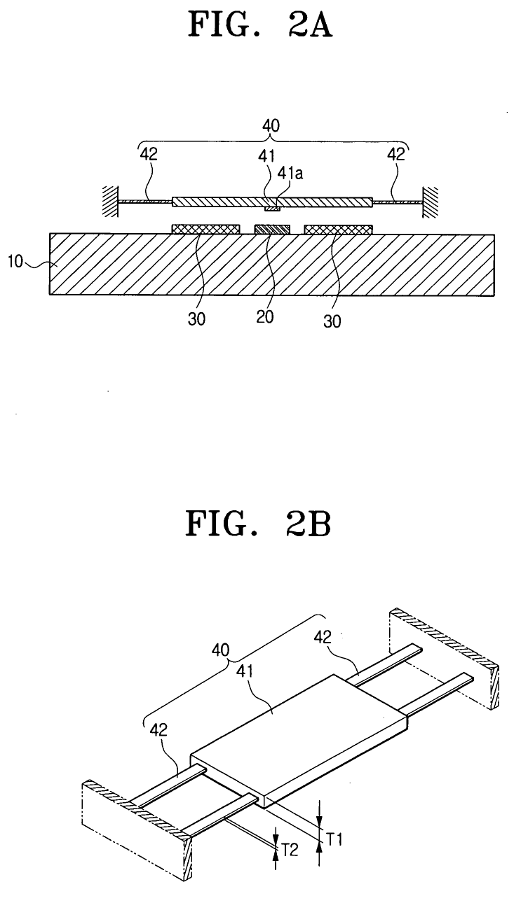

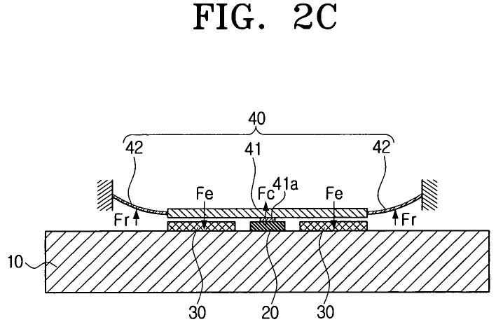

FIG. 2A is a schematic structure view exemplifying a MEMS switch according to a first exemplary embodiment of the present invention, and FIG. 2B is a perspective view of a moving beam of the MEMS switch of FIG. 2A.

As illustrated in FIGS. 2A and 2B, the MEMS switch according to the first exemplary embodiment of the present invention includes a substrate 10, a signal line 20, two electrodes 30 and a moving beam 40.

To be more specific, the two electrodes 30 are formed on the substrate 10, and the signal line 20 is formed between the two electrodes 30 on the substrate 10. The signal line 20 has a signal contact part (not illustrated) at which it is broken with a certain gap. The signal line 20 and the electrodes 30 are formed of a conductive material, e.g., Au.

The moving beam 40 is disposed in the shape of membrane, both ends of which are supported, and in a spaced apart relation with respect to the substrate 10 above the substrate 10. The moving beam 40 is provided with a body 41, and supports 42 to support the body 41. The body 41 is a plate having an uniform thickness, and has a contact member 41a disposed at an undersurface thereof. At least one support is disposed at each end of the body 41. The illustrated exemplary embodiment has two supports at each end. The body 41 has a modulus of elasticity far larger than that of the supports 42. For this, the body 41 is formed, so that, for instance, it has a thickness T1 far larger than a thickness T2 of the supports 42.

As illustrated in FIG. 2C, according to the MEMS switch according to the first exemplary embodiment of the present invention constructed as described above, when the electrodes 30 are applied with a voltage, an electrostatic force is produced between the electrodes 30 and the moving beam 40 to attract the moving beam 40 toward the substrate 10. As a result, the moving beam 40 is moved downward, so that the contact member 41a of the body 41 comes in contact with the signal contact part of the signal line 20 to transmit a signal through the signal line 20. At this time, as the body 41 has the modulus of elasticity far larger than that of the supports 42, the body 41 is seldom bent when the moving beam 40 is moved downward. Accordingly, the moving beam 40 is prevented from being stuck when the electrodes 30 are not applied with the voltage and thereby the moving beam 40 is easily returned to its original position once the voltage is removed from the electrodes 30.

On the other hand, the contact force F_{c} generated between the moving beam 40 and the signal line 20 in the operation of the MEMS switch according to the first exemplary embodiment of the present invention can be represented by the following mathematical formula 2.

F_{c}=Fₑ−Fᵣ [Mathematical formula 2]

Here, Fₑ is an electrostatic force and Fᵣ is a reaction force.

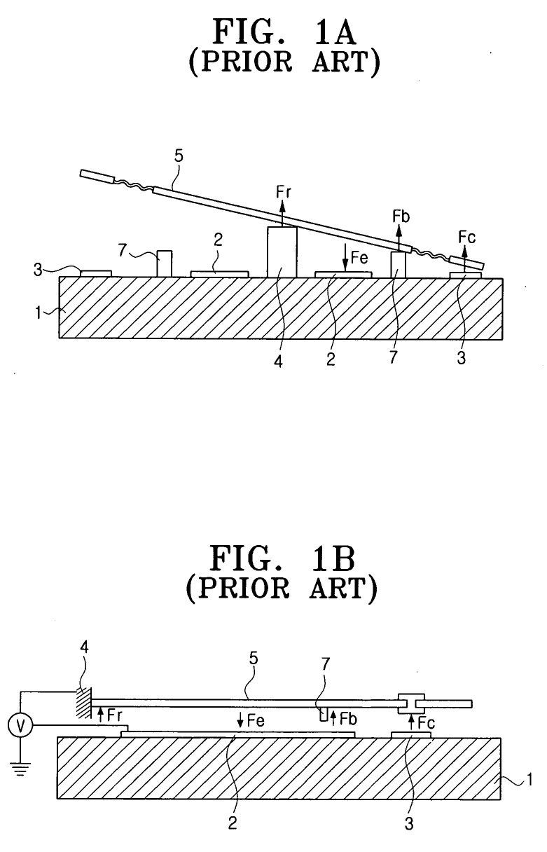

As represented in the mathematical formula 2, the contact force F_{c} is a value, which deducts the reaction force Fᵣ generated at fixed portions of the moving beam 40 from the electrostatic force Fₑ generated between the electrodes 30 and the moving beam 40. Drawing a comparison between the mathematical formulas 1 and 2, the contact force F_{c} in the MEMS switch according to the first exemplary embodiment of the present invention does not include the reaction force F_{b}, which is generated by the bump 7 to be deducted from the electrostatic force Fₑ as in the MEMS switch of FIGS. 1A and 1B. Accordingly, if the electrodes 30 and 2 are applied with the same level of voltage, the MEMS switch according to the first exemplary embodiment of the present invention can obtain a contact force F_{c} which is far larger than that generated between the moving beam 5 and the signal line 3 in the MEMS switch of FIGS. 1A and 1B. That is, the MEMS switch according to the first exemplary embodiment of the present invention has an increased contact force F_{c} between the moving beam 40 and the signal line 30, so that it can stably transmit a signal.

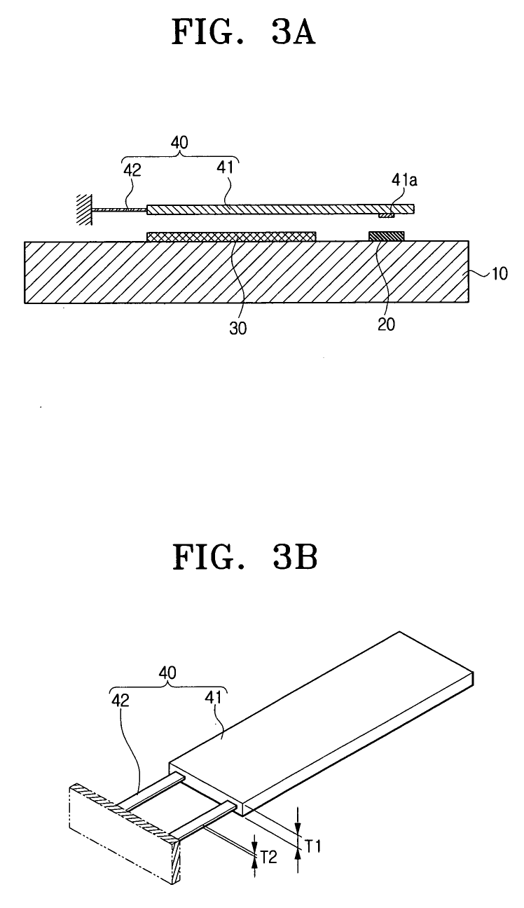

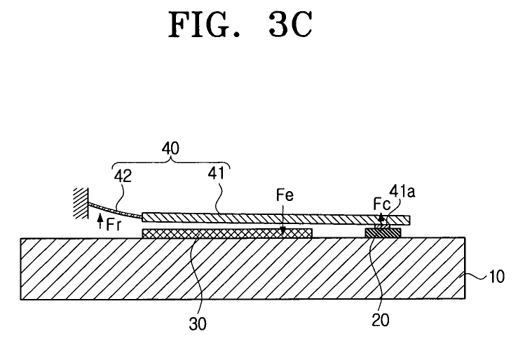

FIG. 3A is a schematic structure view exemplifying a MEMS switch according to a second exemplary embodiment of the present invention, and FIG. 3B is a perspective view of a moving beam of the MEMS switch of FIG. 3A.

As illustrated in FIGS. 3A and 3B, the MEMS switch according to the second exemplary embodiment of the present invention includes a substrate 10, a signal line 20, an electrode 30, and a moving beam 40.

The MEMS switch of the second exemplary embodiment is similar to the MEMS switch of the first exemplary embodiment explained with reference to FIG. 2, except that the moving beam 40 is configured in the shape of a cantilever, one end of which is supported. As with the first exemplary embodiment, in the second exemplary embodiment the moving beam is in a spaced-apart relation with respect to the substrate 10 and is above the substrate 10. Accordingly, elements carrying out functions similar to those of the MEMS switch of the first exemplary embodiment are marked by the same reference numerals, and descriptions of functions and constructions thereof are omitted for clarity and conciseness.

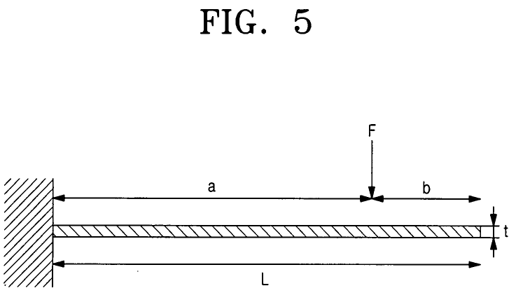

The moving beam 40 is provided with a body 41, and supports 42 to support the body 41. The body 41 is a plate having an uniform thickness, and has a contact member 41a disposed at an undersurface thereof. At least one support 42 is disposed to one end of the body 41 and the present exemplary embodiment shows two. The body 41 has a modulus of elasticity which is far larger than that of the supports 42. For this, the body 41 is formed, so that, for instance, it has a thickness T1 far larger than a thickness T2 of the supports 42. The correlation between the modulus of elasticity and the thickness of the moving beam is described with reference to the exemplary moving beam of a cantilever type as shown in FIG. 5, but other various types of moving beams may be adequately applied.

### If load F is applied to the moving beam of a cantilever type having a length L, a width W, a thickness t and a modulus of elasticity k, the maximum deflection is

$$δ = \frac{{Fa}^{2} ( 3 L - a )}{6 EI} ,$$

where E is Young's modulus and I is the moment of inertia.

### In general, the relation between force and deflection is F=kδ.

### In the moving beam of a cantilever type, the moment of inertia is

$$I = \frac{{Wt}^{3}}{12} .$$

Therefore, K∝t³ is acquired by combination of the above three equations. That is, a modulus of elasticity of the moving beam is proportional to the cube of the thickness of the moving beam.

An operation of the MEMS switch of the second exemplary embodiment of the present invention constructed as described above is similar to the MEMS switch of the first exemplary embodiment. That is, since the body 41 has a modulus of elasticity far larger than that of the supports 42, the body 41 is seldom bent when the moving beam 40 is moved downward. Accordingly, the moving beam 40 is prevented from being stuck when the electrode 30 is not applied with the voltage and thereby the moving beam 40 is easily returned to its original position, when the voltage is removed from the electrode 30. Also, the MEMS switch of the second exemplary embodiment of the present invention does not include the reaction force F_{b}, which is generated by the bump 7 to be deducted from the electrostatic force Fₑ as in the MEMS switch of FIGS. 1A and 1B. Accordingly, if the electrodes 30 and 2 are applied with the same level of voltage, the MEMS switch of the second exemplary embodiment of the present invention can obtain the contact force F_{c} far larger than that generated between the moving beam 5 and the signal line 3 in the MEMS switch of FIGS. 1A and 1B. That is, the MEMS switch of the second exemplary embodiment of the present invention has an increased contact force F_{c} between the moving beam 40 and the signal line 30, so that it can stably transmit a signal.

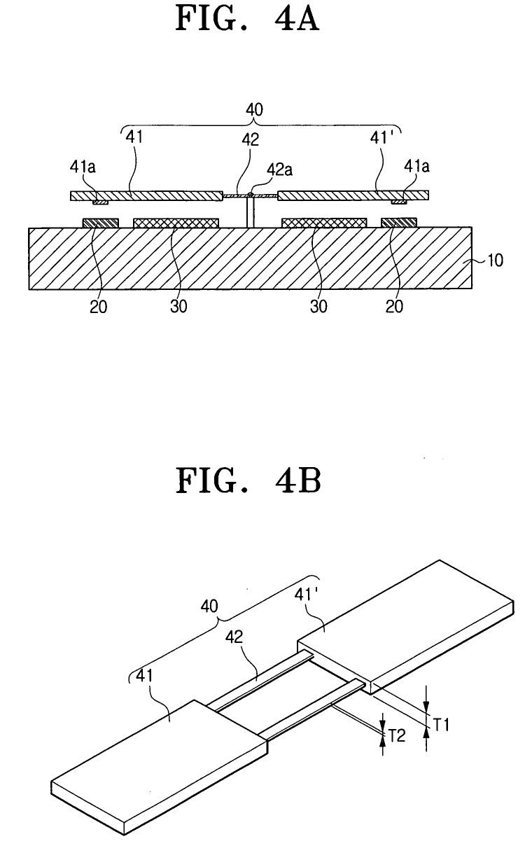

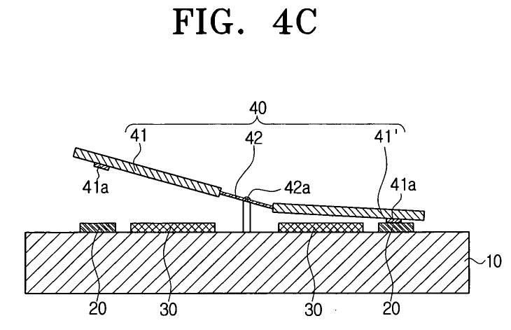

FIG. 4A is a schematic structure view exemplifying a MEMS switch according to a third exemplary embodiment of the present invention, and FIG. 4B is a perspective view of a moving beam of the MEMS switch of FIG. 4A.

As illustrated in FIGS. 4A and 4B, the MEMS switch according to the third exemplary embodiment of the present invention includes a substrate 10, two signal lines 20, two electrodes 30, and a moving beam 40.

The MEMS switch of the third exemplary embodiment is similar to the MEMS switch of the first exemplary embodiment explained with reference to FIG. 2, except that the moving beam 40 is configured to seesaw. As with the previous exemplary embodiments, the moving beam of the third exemplary embodiment is disposed in a spaced-apart relation with respect to the substrate 10 above the substrate 10. Accordingly, elements carrying out functions similar to those of the MEMS switch of the first exemplary embodiment are marked by the same reference numerals, and descriptions of functions and constructions thereof are omitted for clarity and conciseness.

The moving beam 40 is provided with two bodies 41 and 41′, and supports 42 to support interconnecting the bodies 41 and 41′. The supports 42 are disposed to pivot on a pivot 42a. Each of the bodies 41 and 41′ is a plate having an uniform thickness, and has a contact member 41a disposed at an undersurface thereof. There is at least one support 42 disposed to interconnect the bodies 41 and 41′ and the exemplary embodiment includes two supports 42. Each of the bodies 41 and 41′ has a modulus of elasticity far larger than that of the supports 42. For this, each of the bodies 41 and 41′ is formed, so that, for instance, it has a thickness T1 far larger than a thickness T2 of the supports 42.

An operation of the MEMS switch of the third exemplary embodiment of the present invention constructed as described above is similar to the MEMS switch of the first exemplary embodiment. That is, since each of the bodies 41 and 41′ has the modulus of elasticity far larger than that of the supports 42, the bodies 41 and 41′ are seldom bent when the moving beam 40 is moved downward. Accordingly, the moving beam 40 is prevented from being stuck when the electrodes 30 are not applied with the voltage and thereby the moving beam 40 is easily returned to its original position when the voltage is removed from the electrodes. Also, the MEMS switch of the third exemplary embodiment of the present invention does not include the reaction force F_{b}, which is generated by the bump 7 and deducted from the electrostatic force Fₑ as in the MEMS switch of FIGS. 1A and 1B. Accordingly, if the electrodes 30 and 2 are applied with the same level of voltage, the MEMS switch of the third exemplary embodiment of the present invention can obtain a contact force F_{c} far larger than that generated between the moving beam 5 and the signal line 3 in the MEMS switch of FIGS. 1A and 1B. That is, the MEMS switch of the third exemplary embodiment of the present invention has an increased contact force F_{c} between the moving beam 40 and the signal line 30, so that it can stably transmit a signal.

As previously noted, although in the exemplary embodiments of the present invention, the moving beam 40 is illustrated as having the body 41 and/or 41′ and the supports 42, which are integrally formed with each other and having different modulus of elasticity, the present invention is not limited to that. For instance, the moving beam can be configured, so that it is supported by a separate elastic member (not illustrated) instead of the supports. In that instance, the moving beam would have a modulus of elasticity larger than that of the separate elastic member.

A method of fabricating the MEMS switch according to the exemplary embodiments of the present invention is as follows. First, at least one signal line 20 and at least one electrode 30 are formed on a substrate 10. Next, a moving beam 40 in which a body 41 and/or 41′ has a has a modulus of elasticity larger than that of supports 42 is disposed above or on the substrate 10 in a spaced-apart relation with respect to the substrate 10. As a result, the fabrication of the MEMS switch is completed.

The foregoing embodiments and advantages are merely exemplary, and the matters defined in the description such as the detailed construction and the elements are not to be construed as limiting the present invention and are provided to assist in a comprehensive understanding of the embodiments of the invention. Accordingly, those of ordinary skill in the art will recognize that various changes and modifications of the embodiments described herein can be made without departing from the scope and spirit of the invention.

According to the exemplary embodiments of the present invention as described above, the moving beam of the MEMS switch is configured, so that the body or bodies has the modulus of elasticity far larger than that of the supports. Accordingly, the MEMS switch according to the exemplary embodiments of the present invention can prevent the moving beam from being stuck in the operation.

Further, according to the exemplary embodiments of the present invention, there is no need for the MEMS switch to additionally install the bumps for preventing the moving beam from being stuck. Accordingly, the working efficiency can be improved.

Also, according to the exemplary embodiments of the present invention, the MEMS switch is configured, so that it has the increased contact force between the moving beam and the signal line, thereby enabling the signal to be stably transmitted.

Although representative embodiments of the present invention have been shown and described in order to exemplify the principle of the present invention, the present invention is not limited to the specific embodiments. It will be understood that various modifications and changes can be made by one skilled in the art without departing from the spirit and scope of the invention as defined by the appended claims. Therefore, it shall be considered that such modifications, changes and equivalents thereof are all included within the scope of the present invention.

What is claimed is:

1. A MEMS switch comprising:
a substrate;
at least one signal line and at least one electrode formed on the substrate; and
a moving beam disposed in a spaced-apart relation with respect to the substrate and above the substrate so as to be connected with or disconnected from the signal line according to an operation of the electrode;
wherein the moving beam comprises at least one body, and at least one support to support the body, the body having a modulus of elasticity larger than that of the support.

2. The MEMS switch as claimed in claim 1, wherein the moving beam is configured so that the body has a thickness larger than that of the support.

3. The MEMS switch as claimed in claim 1, wherein the moving beam is configured so that at least one support is disposed at each of two ends of the body.

4. The MEMS switch as claimed in claim 1, wherein the moving beam is configured, so that at least one support is disposed at one end of the body.

5. The MEMS switch as claimed in claim 1, wherein the moving beam is configured so that at least one support is disposed to connect two bodies with each other and to be pivotable.

6. A MEMS switch comprising:
a substrate;
at least one signal line and at least one electrode formed on the substrate; and
a moving beam supported by an elastic member in a spaced-apart relation with respect to the substrate and above the substrate, the moving beam being connected with or disconnected from the signal line according to an operation of the electrode;
wherein the moving beam has a modulus of elasticity larger than that of the elastic member.

7. A method of fabricating a MEMS switch comprising:
forming at least one signal line and at least one electrode on the substrate; and
disposing a moving beam in a spaced-apart relation with respect to the substrate and above the substrate, the moving beam being configured so that a body has a modulus of elasticity larger than that of a support.
